(19) United States
(12) Patent Application Publication
(10) Pub. No.: US 2024/0158156 A1
(43) Pub. Date: May 16, 2024

(54) DISPENSER AND CONTAINER FOR DISPENSING SHEET-TYPE MATERIAL

(71) Applicant: Hans Georg Hagleitner, Zell am See (AT)

(72) Inventor: Hans Georg Hagleitner, Zell am See (AT)

(21) Appl. No.: 18/418,601

(22) Filed: Jan. 22, 2024

Related U.S. Application Data
(63) Continuation of application No. PCT/AT2022/060259, filed on Jul. 20, 2022.

(30) Foreign Application Priority Data
Jul. 21, 2021 (AT) A 50603/2021

(51) Int. Cl. B65D 83/08; A47K 10/32

(52) U.S. Cl. CPC B65D 83/0805; A47K 10/32; A47K 2010/3226; A47K 2010/3266; B65D 2203/00

(57) ABSTRACT

A dispenser for dispensing sheet-type material, in particular wet wipes, includes a receiver for a replaceable container which contains the sheet-type material (6) within a wall made of at least partially flexible material, and which has a transparent region in the wall. A sensor device which can receive light coming from the vicinity of the transparent region of the container outputs electrical sensor signals according to the received light. An evaluation unit evaluates the electrical sensor signals. A container for a sheet-type material dispenser includes a wall formed at least partially of flexible material, in particular a plastic film. The wall preferably has a cover section next to the removal opening with at least one transparent region.

### CROSS-REFERENCE TO RELATED APPLICATION

This application is a continuation, under 35 U.S.C. § 120, of copending International Patent Application PCT/AT2022/060259, filed Jul. 20, 2022, which designated the United States; this application also claims the priority, under 35 U.S.C. § 119, of Austrian Patent Application A 50603/2021, filed Jul. 21, 2021; the prior applications are herewith incorporated by reference in their entirety.

### FIELD AND BACKGROUND OF THE INVENTION

The invention relates to a dispenser for dispensing sheet-type material, in particular wet wipes.

The invention furthermore relates to a container for sheet-type material, in particular for a dispenser according to the invention.

### DESCRIPTION OF THE RELATED ART

Wet wipes are usually provided in so-called flow packs. Among other things, such flow packs have a packaging made of a thin, flexible plastic film, in which the wet wipes are accommodated. On the top there is a removal opening, which is tightly sealable in order to prevent the wet wipes contained therein from drying out.

Quite simple dispensers in which such flow packs can be inserted are also known. Those dispensers usually have a spring-loaded plate, which presses on the packaging from below and thus pushes the wet wipes contained therein towards the removal opening.

### SUMMARY OF THE INVENTION

It is accordingly an object of the invention to provide an improved dispenser for dispensing sheet-type material, in particular wet wipes, as well as a container suited thereto, which overcome the hereinafore-mentioned disadvantages of the heretofore-known devices of this general type and in which information about the inserted container, in particular the level of fill with sheet-type material, can be detected and/or communicated.

With the foregoing and other objects in view there is provided, in accordance with the invention, a dispenser for dispensing sheet-type material, in particular wet wipes, with a receiver for a replaceable container, which contains the sheet-type material within a wall made of at least partially flexible material, and which has a transparent region in the wall, a sensor device, which can receive light coming from the region of the transparent region of the container and outputs electrical sensor signals in dependence on the received light, and an evaluation device for evaluating the electrical sensor signals.

With the objects of the invention in view, there is additionally provided a container for sheet-type material, in particular for a dispenser according to the invention, with a wall, which is at least partially formed of flexible material, in particular of a plastic film, and wherein the wall has a cover section and an opposite base section, between which the sheet-type material can be disposed, a removal opening in the cover section for removing the sheet-type material, and the wall, preferably the cover section of the wall next to the removal opening, has at least one transparent region.

With the objects of the invention in view, there is also provided a container for sheet-type material, in particular for a dispenser according to the invention, with a wall, which is at least partially formed of flexible material, in particular of a plastic film, wherein the wall has a cover section and an opposite base section, between which the sheet-type material can be disposed, with a removal opening in the cover section for removing the sheet-type material, the wall, preferably the cover section of the wall next to the removal opening, has at least one transparent region, and, from the inside of the container, the base section appears opaque and/or colored in a region opposite the transparent region of the cover section.

With the objects of the invention in view, there is concomitantly provided a container for sheet-type material, in particular for a dispenser according to the invention, with a wall, which is at least partially formed of flexible material, in particular of a plastic film, and wherein the wall has a cover section and an opposite base section, between which the sheet-type material can be disposed, with a removal opening in the cover section for removing the sheet-type material, the wall, preferably the cover section of the wall next to the removal opening, has at least one transparent region, and the transparent region is formed, for example, as a rectangular or round viewing window, which is surrounded by a region of the cover section appearing opaque or colored.

The basic concept of the invention is to provide a transparent region in the containers (flow packs), usually printed opaque or colored, which makes it possible to see into the interior of the container (even when the removal opening is closed). This can, in principle, be done with the user's naked eye. However, it is preferably provided that a light source which casts light through the transparent region of the wall into the interior of the container is allocated to the sensor device, wherein the sensor device detects at least a part of the reflected light.

One possible mode of operation is then the following: if the container is filled with sheet-type material, in particular wet wipes, which have a highly reflective white color for example, the sensor receives a corresponding signal, and the evaluation device recognizes that sheet-type material is still available. If this sheet-type material has run out, the sensor device receives reflected light from the inside of the base section, which is preferably formed opaque or colored and thus different from the sheet-type material in terms of its reflection behavior. The sensor device together with the evaluation device can thus recognize that sheet-type material is no longer available and, for example, actuate an empty indicator on the dispenser itself in dependence thereon. However, it is also possible that this empty information is communicated, in particular also wirelessly, to further devices so that, for example, a member of staff can refill the dispenser.

If the inside of the base section has a particular color, and a plate, which presses the container in the dispenser upwards, has a different color, then the dispenser can also recognize whether a container is inserted at all because, if a container is not inserted, the sensor device receives light that is reflected by the plate. If this is formed opaque or in a different color from the inside of the base section, it is possible to distinguish between an empty container and the fact that a container is not inserted at all, due to the different reflection.

Further advantageous embodiments of the dispenser and the container are defined in the dependent claims.

Other features which are considered as characteristic for the invention are set forth in the appended claims.

Although the invention is illustrated and described herein as embodied in a dispenser and a container for dispensing sheet-type material, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, longitudinal-sectional view of an embodiment example of a dispenser according to the invention;

FIGS. 2 to 4 are fragmentary, cross-sectional views of an embodiment example of a dispenser with a full container (FIG. 2), with an empty container (FIG. 3) and with no container (FIG. 4);

FIG. 5 is a fragmentary, cross-sectional view through a part of an embodiment example of a container according to the invention;

FIGS. 6 and 7 are cross-sectional views of a further embodiment example of a container according to the invention, once in the full state (FIG. 6) and once in the empty state (FIG. 7); and

FIGS. 8 and 9 are cross-sectional views through further embodiment examples of the invention.

### DETAILED DESCRIPTION OF THE INVENTION

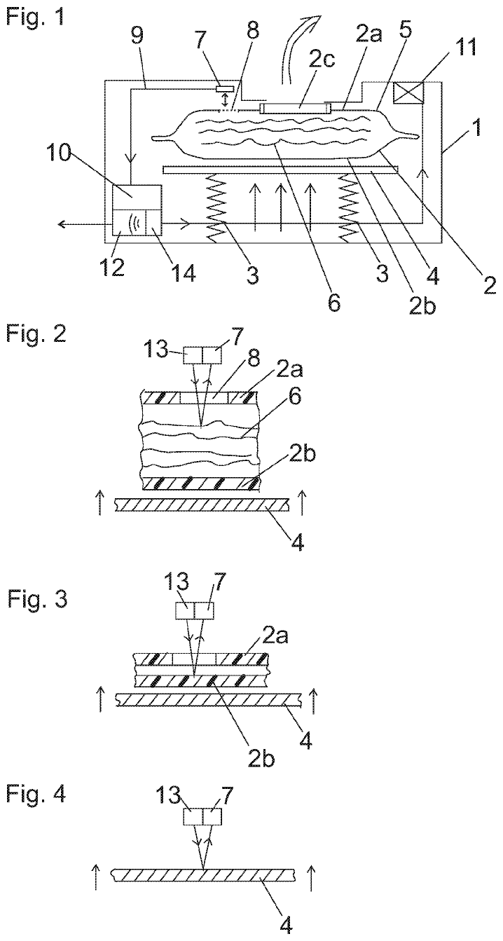

Referring now to the figures of the drawings in detail and first, particularly, to FIG. 1 thereof, there is seen a dispenser which has a container 2 (flow pack) for sheet-type material, in particular wet wipes, in a diagrammatically represented housing 1.

A thrust plate 4, driven by springs 3 or by a non-illustrated motor, presses on this container 2 from below and thus pushes the container 2 with its wall 5 made of flexible material, in particular a plastic film, together with the sheet-type material 6 located therein, upwards. The container 2 has a cover section 2a and an opposite base section 2b. The sheet-type material 6, in particular wet wipes, is disposed between these two sections 2a and 2b. They can be removed from a removal opening 2c in the cover section 2a.

In the figures, the thrust plate 4 and the container 2 as well as the housing 1 are represented with a spacing. In reality, these parts naturally fit closely against one another when the thrust plate presses from below.

According to the invention, the dispenser according to FIG. 1 has a sensor device 7.

For its part, the container 2 for sheet-type material has a transparent region 8 in the cover section 2a next to the removal opening 2c. This region is represented by a dashed line in FIG. 1. Like the rest of the wall, it is closed and thus moisture tight. However, it is transparent to light. In principle, various types of light can be used, in particular visible light. However, it is also possible to use infrared light. The respective statements about the transparency then relate to the light being used.

The sensor device 7 receives light from the interior of the container through the transparent region 8 and outputs electrical sensor signals on a line 9 in dependence thereon. They are evaluated in an electronic evaluation device 10.

As will be explained in even more detail below, through the use of this configuration, for example, the fill level of the inserted container can be determined because the reflection of the light also entering through the transparent region 8 depends on the presence of a sheet-type material. Should the sensor device 7 and the evaluation device 10 establish that sheet-type material 6 is no longer available in the container 2, for example an empty indicator 11 can be (optically or acoustically) activated by a control device 14.

It is also possible to communicate the fill level of the container to further devices by using a device 12 for the wireless transmission of data, for example via a WLAN network or another wireless form of communication. Statistical evaluations about the fill level of the containers and also plans of action for refilling the container by corresponding members of staff are thus also possible.

FIGS. 2 to 4 disclose various states of the container diagrammatically. In FIG. 2 the container is full, in FIG. 3 the container is empty and in FIG. 4 the container is not inserted at all. The sensor device according to the invention, together with the evaluation device, can recognize all of those conditions and differentiate between them.

According to a preferred embodiment example of the invention, it is provided that a light source 13 which casts light through the transparent region 8 of the wall 5 into the interior of the container, is allocated to the sensor device 7, wherein the sensor device 7 detects at least a part of the reflected light.

The light source 13 can be integrated in the sensor device.

According to FIG. 2, the sensor device 7 receives a corresponding signal from the usually white wet wipes 6 and thus the evaluation device 10 recognizes that such sheet-type material (wet wipes) is inserted.

It is not necessary to form the whole container out of transparent material. On the contrary, it is even preferably provided that only for example a rectangular or round viewing window is formed, which is surrounded by a region of the cover section appearing opaque or colored. The base section can also be completely opaque or colored. It is thus possible to print on the wall and thus to give the user information about the contents, as is usual in the case of this type of flow pack.

The transmittance of the transparent region for visible light and/or infrared light preferably lies above 70%, and quite preferably above 90%. It can thus be ensured that the scanning light passes into the container from the outside and then back to the sensor device relatively loss-free.

In FIG. 3, a situation is represented in which the sheet-type material 6 (wet wipes) is used up. The sensor device 7 thus “sees” the base section 2b in a region lying opposite the transparent region 8 of the cover section 2a. If it is formed opaque and/or colored, the reflected light differs from the light which is reflected by the inserted wet wipes 6 (FIG. 2). It is thus possible for the evaluation device to distinguish whether wet wipes 6 are inserted or not.

It is even possible to go one step further: in FIG. 4 no container at all is inserted. The sensor device thus “sees” the thrust plate 4. If its color, for example, is formed differently from the inside of the base region of the container, then this state according to FIG. 4 (no container inserted) can also be distinguished from the states of FIG. 2 (full container) and FIG. 3 (empty container).

The transmittance for visible and/or infrared light of the opaque and/or colored region is less than 20%, preferably less than 5%. It is preferably furthermore provided that the reflectance for visible light and/or infrared light of the colored region on the inside of the base section 2b is more than 60%, preferably more than 80%, so that sufficient light can pass back to the sensor device 7.

The container according to the invention is preferably formed as a flow pack,
in which a plastic film is joined, preferably welded or glued, along a longitudinal join line running in a longitudinal direction to form a tube, and
in which opposite tube sections are joined, preferably welded or glued, to one another in each case along a transverse join line running transverse to the longitudinal join line, forming a substantially closed container.

A dimensionally stable body, which is tightly joined to the rest of the wall of the cover section, and which contains the removal opening, is beneficially provided in the cover section. A closure can also be provided, which tightly seals the removal opening.

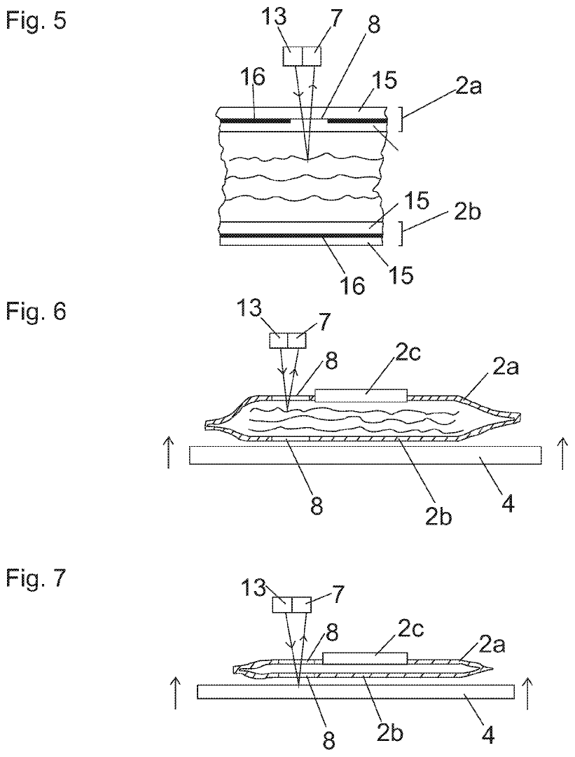

The plastic film of the wall 5 can preferably be printed colored and/or opaque in sections and this printing can in principle be applied on the outside of the film. However, it is also possible for the film to be formed of two or more layers joined to one another and for the printing to be provided between these layers. This situation is represented in FIG. 5. Both the cover section 2a and the base section 2b are in each case formed two-ply. The individual layers 15 are joined to one another in a laminar manner. The printing 16 can be disposed between them. The individual layers 15 themselves are made of transparent material, with the result that the printing 16 is visible from the outside. Where there is no printing, namely in the region of the viewing window (transparent region 8), the cover section 2a of the wall 5 as a whole is transparent. Although the individual layers 15 are also formed of transparent material next to this viewing window, due to the printing, this transparency can be lost in sections, which is also preferably provided.

FIGS. 6 and 7 disclose a further embodiment example in which two viewing windows 8 are provided, namely one in the cover section 2a and one in the base section 2b.

Apart from separate viewing windows 8, as FIGS. 6 and 7 show for example, a larger region of the wall could also be formed transparent, for example the whole left-hand region of the container represented in FIGS. 6 and 7.

In the case of the configuration according to FIGS. 6 and 7, it is possible to distinguish between a full container (FIG. 6) and an empty container (FIG. 7) because the reflected light differs. The light is reflected by the usually white wet wipes in FIG. 6, by the top of the plate 4 in FIG. 7. In contrast to FIGS. 3 and 4, however, in this embodiment example it is not possible to differentiate between a container that is not inserted and an empty one, because in both cases the top of the thrust plate 4 provides the reflected light and this is the same in both cases.

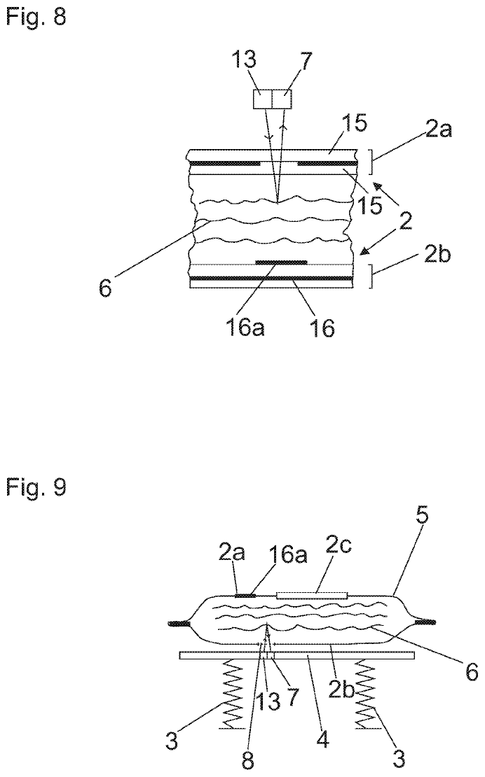

In the embodiment example according to FIG. 8, which shows part of a container 2 filled with wet wipes 6, a label 16a is glued to the inside of the base section 2b. Alternatively, printing on the inside of the label instead would also be possible therein. The advantage of the embodiment example according to FIG. 8 is that, independently of the other printing 16, which is also visible from outside, a reflection or coloration specifically matched to the sensor device 7 is possible therein. Thus, even in the case of different overprints 16 which are visible from the outside, the same reflected light can always be obtained for the sensor as soon as the wet wipes 6 are used up and the sensor “sees” the label 16a.

In the embodiment example represented in FIG. 9, the viewing window 8 is formed on the bottom of the container, thus in the base section 2b. The light source 13 and the sensor device 7 are located in the thrust plate 4. Otherwise, identical reference numbers denote identical or similar parts to those in the earlier figures.

In particular, PET or PE come into consideration as materials for the plastic film of the wall. PET is primarily used for the outer film of a two-ply film; PE is primarily used for the inner film of a two-ply film. However, single-ply or multi-ply films can also be used.

In principle, other plastics such as for example PP, PVC, PS, PLA or PC are also suitable.

The thickness of the plastic film beneficially lies between 40 μm and 300 μm, particularly preferably between 80 μm and 120 μm.

The invention also relates to a dispenser according to the invention with a container according the invention inserted in it.

The invention additionally relates to the use of a container according to the invention for a dispenser according to the invention.

### LIST OF REFERENCE NUMBERS

1 housing
2 container
2a cover section
2b base section
2c removal opening
3 springs
4 thrust plate
5 wall
6 sheet-type material/wet wipes
7 sensor device
8 transparent region/viewing window
9 line
10 evaluation device
11 empty indicator
12 device for the wireless transmission of data
13 light source
14 control device
15 individual layers
16 printing
16a label

1. A dispenser for dispensing sheet-type material or wet wipes, the dispenser comprising:
a receiver;
a replaceable container disposed in said receiver, said replaceable container having a wall made of at least partially flexible material and having a transparent region in said wall, said replaceable container configured for receiving the sheet-type material within said wall;
a sensor device configured for receiving light coming from a vicinity of said transparent region of said replaceable container and for outputting electrical sensor signals in dependence on the received light; and
an evaluation device for evaluating the electrical sensor signals.

2. The dispenser according to claim 1, wherein said sensor device receives light having been reflected by the sheet-type material upon said replaceable container inserted in the dispenser being at least partially filled with the sheet-type material.

3. The dispenser according to claim 1, wherein said sensor device receives light having been reflected by said wall lying opposite said transparent region, or by a label attached opposite said transparent region, or by a printing disposed opposite said transparent region, upon said replaceable container inserted in the dispenser being empty.

4. The dispenser according to claim 1, wherein said sensor device receives light having been reflected by a thrust plate or by a part of a housing, upon no replaceable container being inserted in the dispenser.

5. The dispenser according to claim 1, which further comprises a light source allocated to said sensor device for casting light through said transparent region of said wall into an interior of said replaceable container, said sensor device detecting at least a part of the reflected light.

6. The dispenser according to claim 1, which further comprises a resiliently driven or motor-driven thrust plate acting on a base section of said replaceable container and pressing said base section together with the sheet-type material disposed in said replaceable container towards a cover section of said replaceable container, and said cover section having a removal opening for the sheet-type material.

7. The dispenser according to claim 1, wherein said sensor device detects at least one of an intensity or a spectral composition or a color of the received light and outputs electrical signals to said evaluation device in dependence on the detected intensity or spectral composition or color.

8. The dispenser according to claim 1, wherein said evaluation device includes a device for wired or wireless transmission of data.

9. The dispenser according to claim 1, wherein said evaluation device includes a control device for controlling devices or an empty indicator of the dispenser.

10. A container for sheet-type material, the container comprising:
a wall being at least partially formed of flexible material or a plastic film;
said wall having a cover section and a base section disposed opposite said cover section, for receiving the sheet-type material between said cover section and said base section;
said cover section having a removal opening formed therein for removing the sheet-type material; and
said wall or said cover section of said wall having at least one transparent region adjacent said removal opening.

11. The container according to claim 10, wherein said base section appears to have at least one of an opaque or colored appearance in a region opposite said at least one transparent region of said cover section, as seen from inside the container.

12. The container according to claim 10, wherein said at least one transparent region is formed as a rectangular or round viewing window being surrounded by a region of said cover section appearing opaque or colored.

13. The container according to claim 10, wherein said at least one transparent region has a transmittance for at least one of visible light or infrared light lying above 70%.

14. The container according to claim 10, wherein said at least one transparent region has a transmittance for at least one of visible light or infrared light lying above 90%.

15. The container according to claim 10, wherein said at least one transparent region is surrounded by a region of said wall appearing opaque or colored and having a transmittance for at least one of visible light or infrared light being less than 20%.

16. The container according to claim 10, wherein said at least one transparent region is surrounded by a region of said wall appearing opaque or colored and having a transmittance for at least one of visible light or infrared light being less than 5%.

17. The container according to claim 10, wherein said base section has an inside with a colored region having a reflectance for at least one of visible light or infrared light being more than 60%.

18. The container according to claim 10, wherein said base section has an inside with a colored region having a reflectance for at least one of visible light or infrared light being more than 80%.

19. The container according to claim 10, wherein:
the container is formed as a flow pack having a plastic film joined, welded or glued along a longitudinal join line running in a longitudinal direction to form a tube; and
said tube has opposite tube sections being joined, welded or glued to one another along a transverse join line running transverse to said longitudinal join line, forming a substantially closed container.

20. The container according to claim 10, wherein said cover section has a dimensionally stable body and a remainder of said cover section having said removal opening, and said dimensionally stable body is tightly joined to said remainder.

21. The container according to claim 10, which further comprises an openable closure tightly sealing said removal opening.

22. The container according to claim 10, wherein said plastic film of said wall is a two-ply plastic film formed of:
an outer film of PET; and
an inner film of PE.

23. The container according to claim 10, wherein said plastic film of said wall has a thickness lying between 40 μm and 300 μm.

24. The container according to claim 10, wherein said plastic film of said wall has a thickness lying between 80 μm and 120 μm.

25. The container according to claim 10, wherein said plastic film is printed to be at least one of colored or opaque in sections.

26. The container according to claim 10, wherein said plastic film has two or more layers joined to one another.

27. The container according to claim 26, wherein said layers are mutually adjacent, at least one of said layers is printed on an inside facing another of said layers, and at least one of said layers is formed of transparent material.

28. The container according to claim 10, wherein the container is filled with the sheet-type material or wet wipes.

29. A container for sheet-type material, the container comprising:
a wall having a cover section and a base section disposed opposite said cover section, for receiving the sheet-type material between said cover section and said base section, said wall being at least partially formed of flexible material or of a plastic film;
said cover section having a removal opening formed therein for removing the sheet-type material;
said wall or said cover section of said wall having at least one transparent region adjacent said removal opening; and
said base section having at least one of an opaque or colored appearance in a region opposite said at least one transparent region of said cover section, as viewed from an inside of the container.

30. A container for sheet-type material, the container comprising:
a wall having a cover section and a base section disposed opposite said cover section, for receiving the sheet-type material between said cover section and said base section, said wall being at least partially formed of flexible material or of a plastic film;
said cover section having a removal opening for removing the sheet-type material;
said wall or said cover section of said wall having at least one transparent region disposed adjacent said removal opening; and
said at least one transparent region being formed as a rectangular or round viewing window surrounded by a region of said cover section appearing opaque or colored.

31. The dispenser according to claim 1, comprising:
a container for sheet-type material inserted in the dispenser, said container including:
a wall being at least partially formed of flexible material or a plastic film;
said wall having a cover section and a base section disposed opposite said cover section, for receiving the sheet-type material between said cover section and said base section;
said cover section having a removal opening formed therein for removing the sheet-type material; and
said wall or said cover section of said wall having at least one transparent region adjacent said removal opening.

32. The dispenser according to claim 1, comprising:
a container for sheet-type material inserted in the dispenser, said container including:
a wall having a cover section and a base section disposed opposite said cover section, for receiving the sheet-type material between said cover section and said base section, said wall being at least partially formed of flexible material or of a plastic film;
said cover section having a removal opening formed therein for removing the sheet-type material;
said wall or said cover section of said wall having at least one transparent region adjacent said removal opening; and
said base section having at least one of an opaque or colored appearance in a region opposite said at least one transparent region of said cover section, as viewed from an inside of the container.

33. The dispenser according to claim 1, comprising:
a container for sheet-type material inserted in the dispenser, said container including:
a wall having a cover section and a base section disposed opposite said cover section, for receiving the sheet-type material between said cover section and said base section, said wall being at least partially formed of flexible material or of a plastic film;
said cover section having a removal opening for removing the sheet-type material;
said wall or said cover section of said wall having at least one transparent region disposed adjacent said removal opening; and
said at least one transparent region being formed as a rectangular or round viewing window surrounded by a region of said cover section appearing opaque or colored.

34. A method of using a container, the method comprising:
placing the container according to claim 10 in a dispenser for dispensing sheet-type material or wet wipes; and
providing the dispenser with:
a receiver receiving the container;
a sensor device configured for receiving light coming from a vicinity of said at least one transparent region of the container and for outputting electrical sensor signals in dependence on the received light; and
an evaluation device for evaluating the electrical sensor signals.

35. A method of using a container, the method comprising:
placing the container according to claim 29 in a dispenser for dispensing sheet-type material or wet wipes; and
providing the dispenser with:
a receiver receiving the container;
a sensor device configured for receiving light coming from a vicinity of said at least one transparent region of the container and for outputting electrical sensor signals in dependence on the received light; and
an evaluation device for evaluating the electrical sensor signals.

36. A method of using a container, the method comprising:
placing the container according to claim 30 in a dispenser for dispensing sheet-type material or wet wipes; and
providing the dispenser with:
a receiver receiving the container;
a sensor device configured for receiving light coming from a vicinity of said at least one transparent region of the container and for outputting electrical sensor signals in dependence on the received light; and
an evaluation device for evaluating the electrical sensor signals.
